(19) United States
(12) Patent Application Publication
(10) Pub. No.: US 2006/0202374 A1
(43) Pub. Date: Sep. 14, 2006

(54) Method and apparatus for cooling extruded plastic foil hoses

(76) Inventors: Antal Pelcz, Budaors (HU); Tamas Illes, Lakhegy (HU)

Correspondence Address: YOUNG & THOMPSON, 745 SOUTH 23RD STREET, 2ND FLOOR, ARLINGTON, VA, 22202, US

(21) Appl. No.: 10/554,636

(22) PCT Filed: Apr. 30, 2004
(86) PCT No.: PCT/HU04/00045

§ 371 Date: Oct. 27, 2005

(30) Foreign Application Priority Data
Apr. 30, 2003 (HU) P 0301174

(51) Int. Cl. B29C 55/28; B29C 47/20

(52) U.S. Cl. 264/146; 264/564; 264/237; 425/72.1

(57) ABSTRACT

A method and apparatus for cooling extruded plastic foil hose, which is cooled down by driving a pressurized coolant along the internal and/or external skirt of the foil hose. The coolant is fed in the area of a drawing aperture tangentially to the foil hose, and the coolant thus generated is driven as a spiral stream from the tangential inlet to the outlet by a centrifugal force affecting the coolant along the internal and/or external surface of the foil hose, and by the density and pressure differences between various parts of the coolant. The apparatus includes an internal cooling unit equipped with a distribution drum provided with nozzles with tangential inlets. Its external cooling unit has a tangential inlet, which is in connection with a ring channel around the foil hose, delimited by a tubular element.

### BACKGROUND OF THE INVENTION

The present invention relates to a method and an apparatus for cooling extruded plastic foil hoses, that is, blown tubular plastic foils. Such plastic foil hoses can be used e.g. for packaging of different products.

As it is known, in the traditional way of plastic foil hose production (U.S. Pat. No. 5,607,639) a foil hose is formed from the foil material continuously exiting from a drawing aperture of an extruder nozzle, which is to be cooled rapidly after adequate extension and orientation by blowing. Cooling is usually performed by an airflow, by means of a cooling ring, which cools the external surface of the foil hose and/or a unit cooling the internal surface of the foil hose. Each of these cooling units extracts heat from the foil by heat-transfer.

U.S. Pat. No. 6,068,462 discloses a device for the continuous production of blown foil hoses, which is provided with an internal and an external primary cooling unit, respectively, adjacent to the drawing aperture of the extruder nozzle and has a secondary internal cooling unit in the upper part of the foil hose. The internal primary cooling unit is made up of a series of concentric discs, which are provided with radial groove-like air outlets along their external perimeter. The external cooling unit also consists of discs, which are provided with annular radial air outlets along their internal perimeter. The coolant air flows exit from the inside of the hose through an upper outlet.

As regards foil production, the temperature of the melted foil exiting from the extruder nozzle is generally between 150 and 180° C.; therefore the unstabilized oil must be cooled down relatively rapidly, in the first step to approx. 80 to 100° C. to make it solid, then in the second step to a storage temperature of approx. 20 to 25° C. in order to prevent shrinking and to prevent foil layers from sticking together, and all this before rolling up. With the above foil cooling, however, rapid and even foil cooling cannot always be ensured by the air streams exiting through the radial outlets. This poses a particular problem at higher foil speeds as in such cases there is a relatively shorter time available for cooling; this means that presently foil cooling is a critical phase of the entire foil production technology. As already referred to above, the maximum applicable foil speed for traditional cooling technologies is about 120 m/min, which is a hindrance to further increases of production.

### SUMMARY OF THE INVENTION

The primary object of the present invention is to eliminate the deficiencies mentioned above, that is, to create an improved technology whereby the foil product exiting from the extruder nozzle can be cooled down more rapidly, more evenly, and more efficiently than by the traditional solutions mentioned above. A further object is to increase the productivity of foil production, in general, by increasing the foil cooling efficiency.

This invention provides with a method for cooling extruded plastic foil hoses, where the foil hose—immediately after its continuous exit from a drawing aperture of an extruder device and its blown up to a prescribed size by a pressure medium—is cooled down to a prescribed temperature by driving a pressurized coolant—mainly air, fed in the area of the drawing aperture—along the internal and/or external skirt of the foil hose. The coolant air is fed in the area of the drawing aperture tangentially to the foil hose in order to cool the foil hose internally and/or externally, and the coolant is driven as a spiral coolant stream from the tangential inlet to the outlet by centrifugal force affecting the coolant along the internal and/or external surface of the foil hose, and by density and pressure differences between various parts of the coolant stream. A ring channel, with tangential inlet, delimited by a tubular skirt positioned at a radial distance from the external skirt surface of the foil hose is applied in the case of applying external cooling.

Preferably the internal and external spiral coolant streams are applied simultaneously and in a counter-current.

In or immediately after the final stage of cooling, the foil hose, still of cylindrical shape, may be cut up longitudinally at least of two (or more) places, and the flat foil stripes produced this way are rolled up one by one.

According to the invention the apparatus for cooling extruded foil hoses, arranged in the area of a drawing aperture of an extruder nozzle, having at least one internal and/or external cooling unit arranged in an internal space of the foil hose to be produced and/or along its external skirt, which is provided with an inlet and an outlet and connected to a coolant supply. The external and/or the internal cooling unit(s) has/have at least one inlet arranged tangentially to the foil hose to feed a coolant, particularly cold air. Furthermore, in case of applying the external cooling unit, it is provided with a ring channel delimited by the external skirt surface of the foil hose to be cooled from the inside and by a skirt from the outside.

In a preferred embodiment of the apparatus, the ring channel of the external cooling unit is delimited from the outside advantageously by an arched boundary element, particularly a tubular skirt and/or a conical funnel.

The external cooling unit may have a coolant distribution drum to be mounted coaxially on the extruder nozzle, whose tangential inlet communicates with the slot-like inlet duct coaxially surrounding the foil hose, which latter communicates with the ring channel.

The internal cooling unit may be equipped with a coolant distribution unit, which is provided with nozzles having tangential air feed inlets along the internal skirt perimeter of the foil hose, which are connected to an advantageously controllable pressurized coolant supply and whose radial position is adjustable within the internal space of the foil hose to be cooled. Furthermore, the internal space may be provided, at the end opposite to the nozzles, with a removal pipe open at the exhaust end to remove exhaust coolant from the internal space of the foil hose, the other end of which is connected to a (advantageously controllable) vacuum supply.

In the course of our experiments, we recognised that surprisingly efficient foil cooling can be achieved—departing from the basic principles and arrangements applied for the traditional solutions—by generating a relative speed difference between the coolant and the foil by providing with spiral coolant streams for which the pressurized coolant flow is fed tangentially. The coolant stream thus produced in an external ring channel, advantageously with smooth walls and/or in the internal space of the foil, is forced to move along a spiral motion track particularly by centrifugal force affecting the particles of the coolant medium, and by the difference in density and pressure of the parts of the medium of various temperatures; the medium is to go through the annular space this way, up to its outlet.

So the spiral coolant streams mentioned above are generated by the difference in density and pressure between the warmer and relatively colder parts of the coolant medium stream, which plays an important part, according to our invention, due to tangential coolant inlet. Therefore, the coolant driven in tangentially at a previously specified speed is forced into rotation and progresses through the annular space along a spiral track; therefore its particles are affected by a centrifugal force.

However, according to our experiments, the coolant spiral flow consists of layers within a given cross-section as a result of the centrifugal force and the difference of density between cold and hot coolant parts. As commonly known, the density of cold air is higher (therefore it is heavier), thus the centrifugal force has a more intense impact on it, so the cooler layer within a medium flowing along an annular space is always located radially outside in the annular space. Based on the above principles, the apparatus according to the invention operates by feeding a media of different temperatures, e.g. gases, to cylindrical spaces, e.g. into the external ring channel and the internal annular space of the foil hose, advantageously in a counter current, at high speeds, and always tangentially. The initially colder medium if fed tangentially below (in case of a vertical arrangement), so that the rising stream of air resulting from the heat up of the medium should not hinder but rather further assist the spiral medium flow. On the other hand, an initially relatively hotter medium is fed tangentially above to the annular space for the same consideration, so that the descending air stream resulting from its being cooled down should assist the spiral flow of the medium here as well.

As it is known, heat energy can also be transferred between a flowing gas and a solid body by “dissipation heat-transfer”. In this case, the heat-transfer consists of a heat conduction and convection by way of flowing particles. So the heat energy warms up the gas particle in contact with the solid body, and the particle thus warmed up carries along the heat. The heat-transfer is relatively rapid, because heat energy by moving a gas can be transferred quicker. This way, still air (with heat insulation properties) will become a good heat-transfer medium by streaming.

According to our experiments, the amount of heat transferred during a unit of time depends on the heat-transfer coefficient, the heat-transfer surface, the temperature of the heat-transferring medium, and the temperature of the foil. However, a high-capacity air coolant system is required for generating coolant air, as this air is constantly taken in from and blown back into the atmosphere. On the other hand, the heat-transfer surface cannot be altered because certain geometrical conditions and proportions must be complied with in order to obtain a quality product in the course of foil production, for instance; this means that the surface of the foil is given (constant). Thirdly, the heat-transfer coefficient can be changed within limits. In the case of air, this can primarily be influenced by the relative moisture content and flow speed of air (the relative speed difference between the foil and the air). The degree of heat-transfer can be affected considerably by both factors. The heat-transfer coefficient of still dry air is approx. 5 W/m2K, while that of humid, intensely flowing air is approx. 250 W/m2K. Therefore, the quantity of the removed heat can be increased as much as 50 times by the heat-transfer coefficient.

Our experimental results show that the speed of the coolant gas is limited by the strength of the foil hose. Speed difference between the foil and the coolant, however, can be further increased to a surprising degree by feeding the coolant tangentially in accordance with the invention. Furthermore, according to our experiments, centrifugal forces from the spiral coolant flow—affecting the foil hose—also have a favorable impact on the stability of the foil hose, resulting in astonishing extra technological effects.

Further details of the invention will be described by taking reference to the attached drawings, which show, by way of example, some embodiments of the invention.

### BRIEF DESCRIPTION OF THE DRAWINGS

In the drawings:

FIGS. 1 to 4 illustrate schematically of theoretical operation and arrangement of four embodiments of the foil cooling systems according to the invention;

FIG. 5 illustrates a vertical cross-section of a further embodiment of the foil cooling apparatus according to the invention;

FIG. 6 is a diagram illustrating the triangles of velocity vectors of the foil and coolant air;

FIG. 7 is a further diagram illustrating the absolute values of speed difference vectors;

FIG. 8 illustrates the layer structure of spiral coolant streams according to the invention.

### DETAILED DESCRIPTION OF THE PREFERRED EMBODIMENT

FIGS. 1 to 4 illustrate the theoretical explanation and some potential realisations of the method and apparatus for foil cooling in accordance with the invention.

According to FIG. 1, the first embodiment of the cooling technology according to the invention shows an internal cooling of a foil hose F just exiting from an extruder nozzle aperture (not illustrated). As coolant pressurized air is fed in transversally and tangentially (in sharp contrast to traditional solutions of driving it in radially and parallel with the upward direction of progress of the foil). This way, a swirl (rotation) is given to the coolant stream by the tangential inlet, so the coolant stream will flow along a spiral track (indicated by a continuous line) in accordance with our invention, within a cylindrical inner space of the foil hose F, due to the centrifugal force affecting the coolant stream along the internal surface of the foil hose F, and density and pressure differences between various parts of the coolant stream. Thereby the speed difference between the foil hose progressing upwards to a known drawing-off roller pair H, and the coolant stream flowing upwards along a spiral routes has been increased effectively, as shown by our experiments.

It is to be noted that the external skirt surface of the foil hose F (cooled from the inside in a controlled manner) was also in contact with the atmospheric environment, as a result of which the foil hose F is cooled externally, too, to some degree. The internal coolant air stream progressing upwards from below within the foil hose F (and heated up in the meantime) was sucked away through an upper outlet opening (indicated by dash-and-dot line) of a central pipe C arranged coaxially within the foil hose F. At the top part of FIG. 1, the drawing-off roller pair H is to draw down the foil hose F, before it's rolling up.

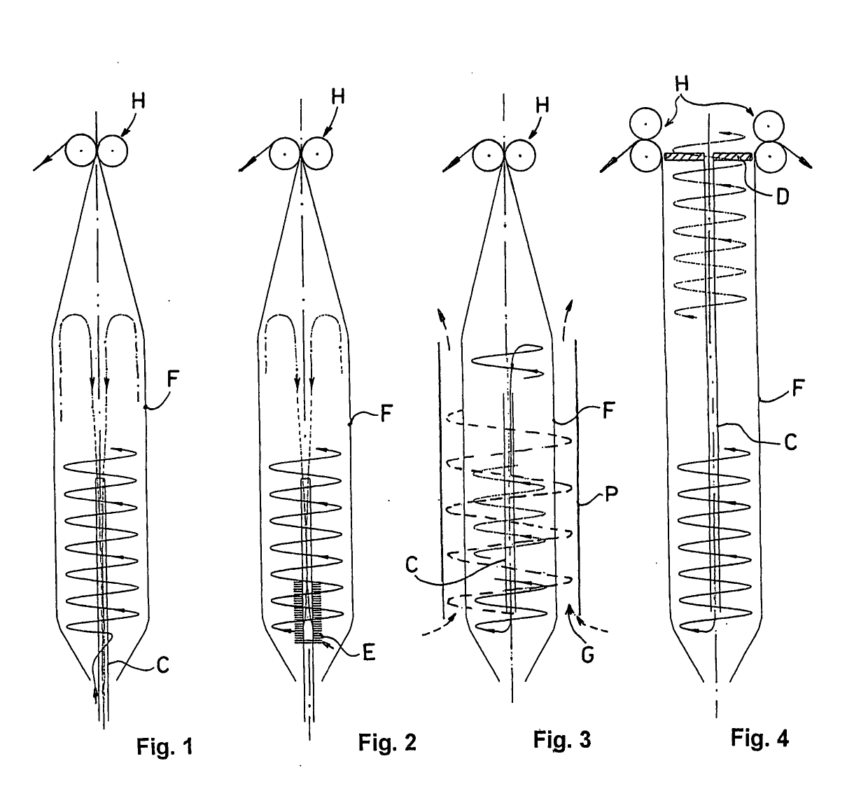

In the embodiment according to FIG. 2, only internal cooling was applied, similarly to the solution illustrated in FIG. 1, where the coolant air stream was also driven into the internal space of the foil hose F from below through at least one tangential inlet (indicated by an arrow), and a spiral coolant stream (indicated by a continuous line) was also generated (as mentioned above).

However, a significant difference lies in that the coolant air is not blown in and the air already heated up is not suck out constantly, but an internal spiral air circulation—and therefore a relatively high speed difference—is generated within the internal space of the foil hose F. The spiral air stream in the internal space of the foil hose F is driven through a pipe C and an air/liquid heat exchanger E arranged centrally within the internal space of the foil hose F. By using said heat exchanger E and by the spiral coolant stream the heat can be extracted from the foil hose F, (by using e.g. a not illustrated water circuit of the heat-exchanger E). An upper drawing-off roll pair H has the same function as mentioned above.

According to the third embodiment illustrated in FIG. 3, a combined external and internal foil cooling was applied in accordance with the invention. The foil hose F is mainly cooled along the external foil surface, but this is combined with internal cooling. This system essentially represents a special combination of intensive spiral-like external cooling and an air circulation inside the foil hose F.

For the external air cooling, a cooling air stream of previously determined pressure is fed into a ring channel G, delimited from the inside by a cylindrical unstabilized section of the foil hose F, and by a cylindrical skirt P from outside. The coolant air is fed into the ring channel G under pressure at a bottom tangential inlet (indicated by dashed arrow). From there, the coolant air stream will flow upwards in a spiral form to an outlet at the open upper end of the ring channel G (this spiral stream is indicated by a thin dotted spiral line), and in the meantime, the foil hose F is effectively cooled down from the outside.

In the course of driving the foil hose F upwards by a drawing-off roll pair H, and as a result of it being cooled from the outside, the internal air kept moving within the internal space of the foil hose F is also cooled down (indicated by a continuous spiral line). The cooled internal air is conducted through the central pipe C back to the lower section of the foil hose F, further improving the efficiency of cooling. The internal air stream conducted back to the lower inlet area is heated up by the heat of the still hot unstabilized section of the foil hose F and it gets colder by the time it reaches the upper end of the return pipe C.

The embodiments according to FIGS. 1 to 3 can be applied if any type of the foil hoses F is to be produced. However, in the event that flat foil should be produced, then first the foil hose F exiting from the extruder and cooled down according to our invention, then it is cut into two or more foil strips of a given size, in the course of the cooling method or in an additional operation (such as the technology illustrated in FIG. 4), and these foil strips can be rolled up.

In FIGS. 1 to 3, the foil hose F was driven plain by the drawing-off roll pair H, that is, it was flattened, and later rolled up in a known manner. However, at the solution according to FIG. 4, the foil hose F is not driven plain, but it is cut up longitudinally by cutting units (not illustrated separately, e.g. rotating cutting disks) to stripes of a given size, which are drawn-off by roll pairs H.

This cutting step is to be performed in or immediately after the final stage of cooling the foil hose F, in the course of which the foil hose—still blown up to a cylindrical shape—is cut up longitudinally at a minimum of two or more places, and the foil stripes produced this way are rolled up one by one. This way flat foils can be produced more simply and productively, besides an increase in the cooling efficiency.

As to the arrangement in FIG. 4, the foil hose F is cooled according to the invention in a way that the coolant air is fed in tangentially below and flowing upwards along a spiral track. But the coolant spiral stream is hindered from free outflow by a plug D acting as a “throttle valve” and located within the foil hose F, close to the height of the drawing-off roll pairs H, which are arranged at a distance from each other. The coolant air warmed up can flow out in a controlled manner to the external area through a gap between the plug D and the upper stabilized section of the cooled foil hose F and/or through openings (not illustrated) provided in the plug D.

In FIG. 4 the plug D is associated with a central pipe C. So in this system, only an internal cooling of the foil hose F was applied. This means that the coolant air flow—fed in tangentially to the internal space of the foil hose F at the lower tangential inlet—will move upwards in spiral streams, therefore the flow conditions can be highly favorable and balanced.

Furthermore, there may be various combinations and versions of the solutions illustrated in FIGS. 1 to 4. Our experiments show that the joint application of external and internal cooling results the most effective cooling of the foil hose F and the highest possible foil production speed.

A common feature of the above cooling systems according to the invention is that the coolant gas, e.g. air, is fed in a tangential plane of the foil hose F under pressure, that is, transversally and tangentially to the driving direction of the foil. It is to be noted that otherwise the tangential coolant stream would tend to remove from the foil, that is why, according to the invention the coolant stream is forced to move along an arched, advantageously spiral path adjacent to the foil by using the centrifugal force affecting the coolant streams along the internal and/or external surface of the foil hose. As the coolant stream delimiting means we used the cylindrical blown foil hose F itself for the internal cooling (see FIGS. 1 to 4), and the external tubular skirt P arranged around the foil hose F, preferably coaxially, forming an external annular space G between an external surface of the foil hose F and an internal surface of the skirt P, for the external cooling (FIG. 3).

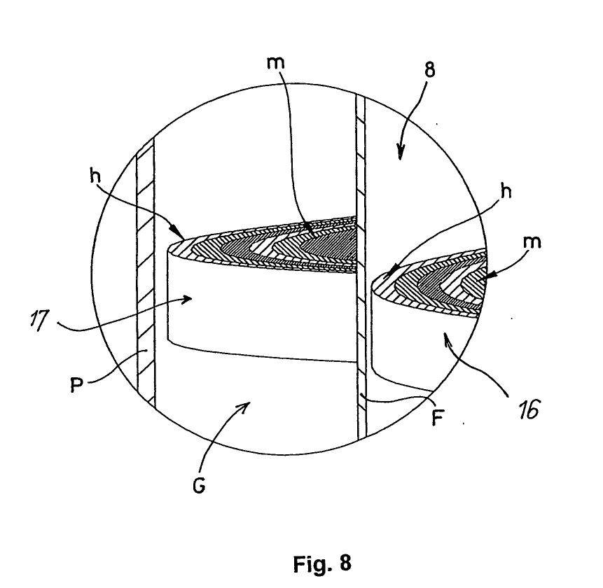

If we examined the tangential coolant inlet stream in itself only, we could establish that the coolant stream would move along a circular track in a tangential plane of the foil hose F, however, during our experiments we recognised that relative pressure differences are established between parts of the coolant stream within the internal space of the foil hose F, or within the external ring channel G (see below FIG. 8, too). These pressure differences can be traced back to two reasons, primarily: the tangential blow-in of the coolant; and secondly: the difference in density of various layers of the coolant stream resulting from the various degrees of warm-up of the various coolant layers. As a consequence, the heat-transfer medium, that is, the coolant stream performs a relative axial displacement as well within the annular space according to the invention. So the theoretical endless “circular track” mentioned above is actually converted into a “spiral track” of the coolant stream according to the invention, providing surprising effects (see below).

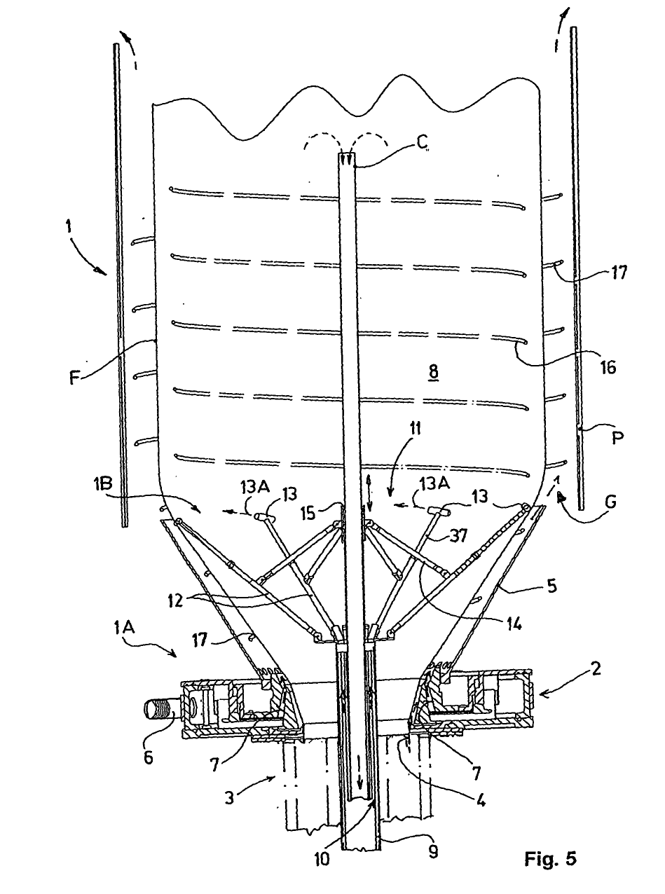

FIG. 5 shows a more detailed preferred embodiment of an apparatus 1 according to the invention, designed for cooling a blown extruded plastic foil hose F. In terms of principle of operation, this embodiment corresponds to a combination of the solutions according to FIGS. 1 and 3, meaning that both external and internal cooling are applied.

In FIG. 5 the apparatus 1 is equipped with an external cooling unit 1A and an internal cooling unit 1B. The external cooling unit 1A comprises a coolant distribution drum 2, mounted on a known extruder nozzle 3 of an extruder machine (not illustrated detailed, just indicated by thin dash-and-dot lines in FIG. 5).

During foil production the foil hose F exits through a drawing aperture 4 from the extruder nozzle 3 in the form of a continuous foil hose F. In FIG. 5 there is a funnel 5 extending conically upwards, arranged on the top part of the coolant distribution drum 2, the conicity of which is selected in accordance with an expansion cylindrical shape of the foil hose F, which is blown up by air stream after its exiting from the drawing aperture 4 (in a manner known by itself).

Furthermore, the external cooling unit 1A is provided with an external tubular skirt P above the funnel 5, coaxially and with a radial distance to the already cylindrical unstabilized section of the foil hose F. In this embodiment the conical funnel 5 and the cylindrical external skirt P jointly delimit an annular duct G from the outside. The foil hose F itself constitutes a “delimiting wall” between the external annular space G and an internal space 8 of the foil hose F. The coolant distribution drum 2 is provided with a tangential inlet 6, which communicates with a slot-like annular duct 7 formed in the drum 2, which is arranged coaxially to the drawing aperture 4 of the foil hose F.

In the present case coolant air having a temperature of 10° C. to 20° C. is fed tangentially through the tangential inlet 6 and the annular duct 7 under a pressure of 1.0 MPa, for instance, and this coolant air stream in rotation enters tangentially first to the lower part of the external ring channel G delimited by the funnel 5. There, due to the effects already detailed above, an external coolant air stream 17 will go upwards in a spiral track along the outer surface of the foil hose F in external ring channel G delimited by the funnel 5 and the skirt P, effectively cooling the foil hose F. This upward spiral coolant air stream 17 was only illustrated partly (for better transparency of the drawing). In the present case, the external ring channel G is open at its top, so the coolant air stream 17 (already warmed up by the heat of the foil hose F) can exit freely into the environment at an upper edge of the skirt P (indicated in FIG. 5 by dashed arrows).

According to FIG. 5, the foil hose F is cooled internally by the internal cooling unit 1B. Coaxially with the foil hose F, a central coolant removal pipe C is applied, whose top end is open in the present case, which communicates with an internal space 8 of the foil hose F; and whose bottom end is connected to a sucking (exhaust) unit (not illustrated). Coaxially with the pipe C, an external pipe 9 is arranged, protruding from the drum 2, this way an annular channel 10 is created between an external surface of the pipe C and an internal surface of the pipe 9, through which, in the present case, coolant air is blown in under pressure to the internal space 8 of the foil hose F (the air fed in under pressure is indicated by dotted arrows).

To the upper end of the channel 10 a coolant distribution unit 11 is connected, which comprises a mechanism (similar to an umbrella frame) being adjustable in radial direction. In the present case, the coolant distribution unit 11 consists of radial and slanting pipes 12, whose lower ends are connected to the duct 10 by sealed and hinged connections, and each of whose external ends is provided with at least one nozzle 13 having a tangential coolant feed inlet 13A. The pipes 12 are hingedly connected to radially outer ends of rods 14, and inner ends thereof are hingedly connected to a sleeve 15 arranged slidably along the pipe C. By axial displacement of the sleeve 15 the radial position of the nozzles 13, in the vicinity of the foil hose F, can be adjusted.

As referred to above, the lower end of the channel 10 is connected to a compressor (not illustrated) for pressing coolant air having a temperature of 20° C. into the internal space 8 of the foil hose F through the channel 10, the pipes 12, and the nozzles 13. The coolant air pressure applied for our experiments was 0.4 MPa. It is to be noted that the applied coolant pressure always depends on the foil thickness; accordingly, even higher inlet air pressures can be selected in the case of thicker foils; our experiments were performed with foil thickness values ranging from 10 to 25 microns.

In accordance with the invention, the coolant inlets 13A of the nozzles 13 are tangential to the internal surface of the foil hose F and can be adjusted thereto. The coolant streams of the inlets 13A jointly form internal spiral coolant stream, which is made into spiral motion along the internal skirt of the foil hose F. These coolant air streams 16 will flow upwards from below, therefore effectively cooling the foil hose F. (This internal spiral coolant flow 16 is indicated partly in FIG. 5 by dotted line.)

The air in the internal spiral coolant flow 16 somewhat warmed up in the internal space 8 is exhausted through the top end of the removal pipe C (indicated by dashed arrows in FIG. 5), where a vacuum of 0.07 MPa was applied for this purpose during our experiments. The vacuum pump is connected to the lower end of the coolant removal pipe C (not illustrated).

In FIG. 5, at least one spiral coolant stream 17 is applied continuously in the external ring channel G, going upwards, and in the inside, an internal spiral coolant stream 16, also going upwards in a spiral form, but in a contrary direction of rotation, compared to the stream 17. These spiral coolant air streams 16 and 17 applied inside and outside in contrary directions, have a highly favourable impact with respect to the orientation of the unstabilized plastic material of the foil hose F besides effective cooling, because they centralize the foil hose F and ensure balanced internal and external effects along the skirt, meaning that they contribute to an even extension and wall thickness of the foil hose F both longitudinally and transversally, which ensures excellent product quality compared to the traditional technologies.

According to our experiments, surprisingly effective foil cooling is obtained by the arrangement illustrated by FIG. 5, which enables us to further increase the speed of foil production, even to a greater degree, which exerts a fundamental effect on the productivity of extruder machinery presently applied. It is to be noted that even the diameter of the blown foil hose F can, at the same time, be controlled by air exhaustion from the internal space 8 through the removal pipe C. Moreover, the same can be used for ensuring a constant value for the diameter of the foil hose F, representing another considerable advantage in extruded foil production.

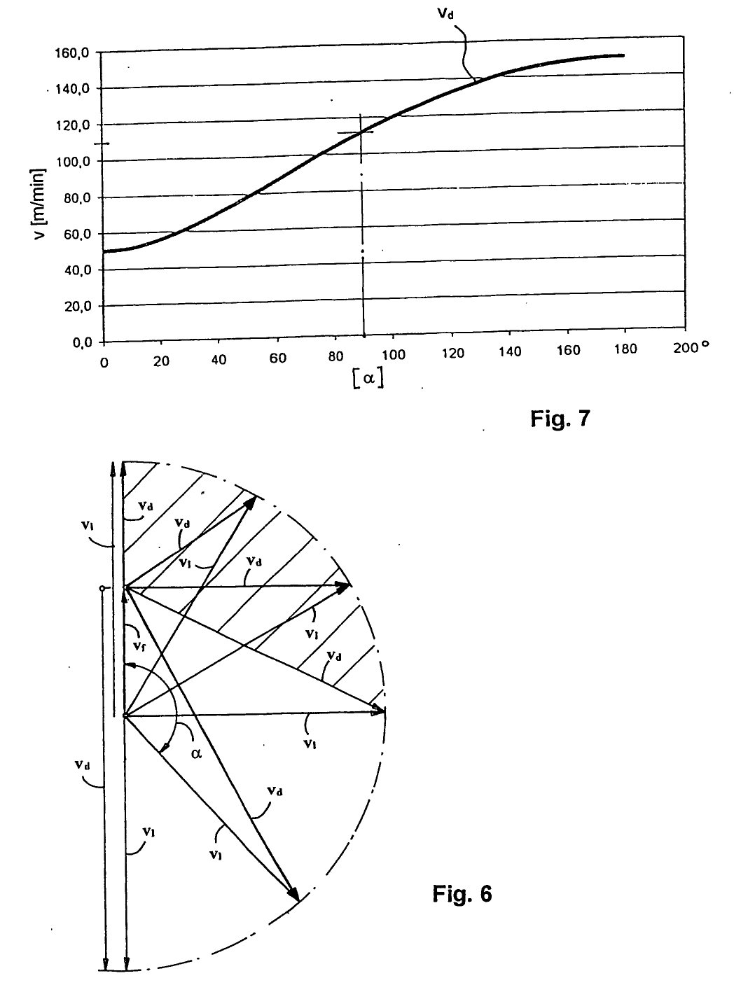

With regard to theoretical explanation of velocity vectors triangles (illustrated in FIG. 6), we note that a flow speed of the coolant air is indicated by vₗ, a driving speed of the foil hose F by v_{f}, an angle therebetween by “α”, and a velocity difference vector by v_{d}.

First, let us examine an arrangement where the coolant air is driven parallel with the direction of the foil hose. In this case, the speed difference is identical with the difference between the absolute values of the velocity vectors. These speed difference vectors are also indicated by v_{d} in FIG. 6. In other words, this means that if the speed of air is 100 m/min, for instance, and the speed of the foil is 50 m/min, then the speed difference v_{d} is 50 m/min. But if the coolant air is fed in an angle α, compared to the foil, then the speed difference will already be a difference of velocity vectors, which is certainly greater than the difference between the absolute velocity values.

The greatest velocity difference would be produced, if coolant were fed in a contrary direction to the foil. In this case, the absolute values would just be aggregated. In our view, practically the perpendicularity (α=90°) of the two velocity vectors seems to be the feasible maximum (see FIG. 6), therefore the maximum speed difference may be relatively high, about 111 m/min, in the case of the data mentioned above.

Thus, FIG. 6 clearly indicates that if the velocity vectors v_{f} and vₗ of the foil and the coolant, respectively, include a given angle α, then the velocity difference vector v_{d} can be easily determined in a known manner. Consequently, there is a cosine function relationship between the angle α and the speed difference vector v_{d}.

In case of the foil velocity of 50 m/min and the air velocity of 100 m/min mentioned as an example above, the absolute value of the velocity difference vector (v_{d}) will be according to the diagram in FIG. 7 in the function of the angle α. This diagram clearly shows (for a person having ordinary skill in the art) that the heat-transfer coefficient obviously increases by raising the velocity difference v_{d}. As a consequence, however, the cooling output is increased. Furthermore, by increasing the cooling output, the track speed of the foil can be increased together with the productivity of foil extruder. This would represent a significant additional impact for foil producers because, up to now, the foil speed is restricted due to insufficient foil cooling technologies.

FIG. 8 illustrates a detail of the external annular duct G and the internal space 8 according to FIG. 5 (in relatively greater scale), also showing various parts, that is radial “layers” of the spiral coolant streams 16 and 17, respectively. In the external ring channel G between the foil hose F and the external tubular skirt P, layers of the coolant stream 17 are formed and positioned in such a way that the closest to the external skirt P is a layer h, that is the coldest part of the air stream, and the closest to the foil hose F is a layer m, that is the hottest part of the air stream. On the other hand, as regards the spiral coolant stream 16 within the internal space 8 of the foil hose F, a radially outermost layer h is the coldest part of the stream, whereas a hottest layer m is located the farthest away from the foil hose F. So, as the hottest layer m of the stream 17 in the external annular duct G is in contact with the foil hose F, and at the same time, on the other side, that is, within the internal space 8, the coldest layer h of the stream 16 is the closest to the foil hose F, thereby the efficiency of heat-transfer is further increased.

Finally, our experimental results clearly show that the efficiency of foil cooling can be effectively increased by the heat transfer method and apparatus according to the invention. Besides the embodiments described above, the solution according to the invention can be realised in many other versions and combinations within the claimed scope of protection. As disclosed above, the present invention can be used widely in the practice. This apparatus is highly feasible with relatively low expenditure even with existing extruder machines.

### LIST OF THE USED REFERENCE CHARACTERS

F—foil hose
C—pipe
H—drawing off roll pair
E—heat exchanger
G—ring channel
P—skirt
D—plug
vₗ—velocity vector of coolant
v_{f}—velocity vector of foil
v_{d}—velocity difference vector
α—angle
1—apparatus for cooling foil hose
1_{A}—external cooling unit
1_{B}—internal cooling unit
2—coolant distribution drum
3—extruder nozzle
4—drawing aperture
5—funnel
6—tangential inlet
7—annular duct
8—internal space
9—pipe
10—channel
11—coolant distribution unit
12—pipes
13—nozzle
13_{A}—inlet
14—rod
15—sleeve
16—internal spiral coolant stream
17—external spiral coolant stream

1-7. (canceled)

8. In a method for cooling extruded plastic foil hose, comprises the steps: feeding pressurized coolant, mainly cooling air, to an external surface of an non-stabilized section of the foil hose; providing a ring channel for coolant stream by using a tubular skirt at a radial distance from the external surface of the foil hose at a drawing aperture of an apparatus for continuous extrusion of the foil hose, mainly extruder nozzle, having a coolant inlet and outlet, and generating at least one external coolant stream between the coolant inlet and outlet of the ring channel, characterised by the steps of providing free outlet for the ring channel and tubular, substantially flat wall surface for the skirt limiting said ring channel (G); directing the external spiral coolant stream (17) generated exclusively by tangential coolant streams to a part of the unstabilized section of the foil hose (F) just exiting from the drawing aperture (4) of the apparatus; and feeding an internal spiral coolant stream (16) generated exclusively by internal tangential coolant streams, in combination with said external spiral coolant stream (17) or in substitution thereof; directing said internal spiral coolant stream (16) on an internal surface of the non-stabilized section of said foil hose (F) for cooling and stabilising the non-stabilized section the foil hose (F); carrying out said foil hose cooling and stabilising steps by purposeful using centrifugal forces affecting the external and/or the internal spiral coolant streams (17, 16) along the external and/or the internal surface of the foil hose (F), as well as density and pressure differences between various parts of the external and/or the internal spiral coolant stream/s (17, 16).

9. A method as claimed in claim 8, characterised by providing two or more tangential inlets and the free (throttling-free) outlet for the external and internal spiral coolant streams (17, 16) in the corresponding ring channel (G, G1).

10. A method as claimed in claim 8, characterised by the additional step of applying both internal and external spiral coolant streams (16, 17) simultaneously, and preferably in counter-current.

11. A method as claimed in claim 8, characterised by the additional step of cutting up the tubular foil hose (F) longitudinally, at least at two places, forming flat foil stripes being rolled up separately by roll pairs (H) during or immediately after the final stage of the foil cooling and stabilizing steps.

12. A method as claimed in claim 9, characterised by the additional step of cutting up the tubular foil hose (F) longitudinally, at least at two places, forming flat foil stripes being rolled up separately by roll pairs (H) during or immediately after the final stage of the foil cooling and stabilizing steps.

13. A method as claimed in claim 10, characterised by the additional step of cutting up the tubular foil hose (F) longitudinally, at least at two places, forming flat foil stripes being rolled up separately by roll pairs (H) during or immediately after the final stage of the foil cooling and stabilizing steps.

14. An apparatus for cooling extruded plastic foil hoses, that is arranged in the area of an extruder nozzle having a drawing aperture, said apparatus comprises an external cooling unit arranged along an external surface of the extruded foil hose, and it is provided with a skirt at a radial distance from the external surface of the foil hose thereby forming a ring channel, and having at least one inlet for a coolant connected to a coolant supply and an outlet; said coolant inlet is arranged to the foil hose in such a way to feed the coolant stream in the channel between the coolant inlet and outlet, characterised in that said external cooling unit (1A) of the cooling apparatus (1) is arranged direct on the extruder nozzle (3) around the drawing aperture (4); said channel forming skirt of the external cooling unit (1A) is formed by a substantially flat tubular skirt (P) and/or a conical funnel (5); said inlet of the channel (G) is formed as a tangential inlet (6, 7) directed to a part of the unstabilized section of the foil hose (F) just exiting from a drawing aperture (4) for generating an external spiral coolant stream (17) for cooling and stabilising the unstabilized section of the foil hose (F) between the tangential coolant inlet (6, 7) and the outlet of the channel (G) which is formed as a free (throttling-free) outlet; the cooling apparatus (1) is provided with an internal cooling unit (1B) in combination with the external cooling unit (1A) or in substitution thereof, arranged within the extruded foil hose (F); said internal cooling unit (1B) is provided with at least one coolant inlet (13A) arranged tangentially to the unstabilized section of the foil hose (F) to feed the coolant in tangential streams for generating an internal spiral coolant stream (16) for cooling and stabilising the unstabilized section of the foil hose (F) between its coolant inlet (13A) and outlet (C).

15. An apparatus as claimed in claim 14, characterised in that the external cooling unit (1A) has a coolant distribution drum (2) mounted direct on the extruder nozzle (3) coaxially with the drawing aperture (4), whose tangential inlet (6) communicates with a ring duct (7) coaxially surrounding the foil hose (F), around a part of the unstabilized section of the foil hose (F) just exiting from the drawing aperture (4), and the ring duct (7) joins the ring channel (G).

16. An apparatus as claimed in claim 14, characterised in that the internal cooling unit (1B) comprises an air distribution unit (11), which is provided with nozzles (13) arranged to direct tangential coolant streams as coolant inlets (13A) to and along internal perimeter of the unstabilized section of foil hose (F); said nozzles (13) are connected to a pressurized coolant supply and their position is adjustable within the internal space of the foil hose (F); the internal cooling unit (1B) is provided with a coolant removal pipe (C) open at its exhaust end, and preferably the other end of which is connected to a vacuum unit.

17. An apparatus as claimed in claim 15, characterised in that the internal cooling unit (1B) comprises an air distribution unit (11), which is provided with nozzles (13) arranged to direct tangential coolant streams as coolant inlets (13A) to and along internal perimeter of the unstabilized section of foil hose (F); said nozzles (13) are connected to a pressurized coolant supply and their position is adjustable within the internal space of the foil hose (F); the internal cooling unit (1B) is provided with a coolant removal pipe (C) open at its exhaust end, and preferably the other end of which is connected to a vacuum unit.
